(19) United States
(12) Patent Application Publication
(10) Pub. No.: US 2002/0140706 A1
(43) Pub. Date: Oct. 3, 2002

(54) Multi-sample method and system for rendering antialiased images

(76) Inventors: James R. Peterson, Portland, OR (US); Robert H. Mullis, Menlo Park, CA (US); Gregory M. Hunter, San Jose, CA (US)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 09/823,935

(22) Filed: Mar. 30, 2001

(51) Int. Cl. G09G 5/00

(52) U.S. Cl. 345/611

(57) ABSTRACT

A method and system for performing multi-sample rendering of antialiased images. The pixels of an image are sampled in accordance with sampling patterns. Each of the sampling patterns defines sampling locations at which sample values are calculated. A value for a pixel in the image is calculated by combining respective sample values.

### TECHNICAL FIELD

The present invention is related generally to the field of sampled imagery, and more particularly, to systems and methods for generating antialiased, sampled images.

### BACKGROUND OF THE INVENTION

In computer graphics, a sampled image is created from input geometry, mathematical computations, and/or the like, typically representing a scene. A sampled image is one represented by an array of discrete units, referred to as pixels. The pixels are generally arranged along two perpendicular axes corresponding to the horizontal and vertical axes of the image. The color or monochrome values of the pixels are determined by calculated sample values, typically derived from scene data, lighting data, and/or other input data. The image represented by the array of pixels is typically transferred to a visual medium, such as by being printed onto paper or film or displayed upon a computer display monitor. The number of pixels and number of colors or values used in rendering a graphics image limit, to some extent, the visual qualities and characteristics of the viewed image, for example, the image definition, smoothness, and detail. A great amount of effort has been devoted to developing sophisticated graphics processing and rendering methods for higher image quality.

In addition to high-quality static images, high-quality animation, depicting visual effects of motion, is also desirable. The illusion of motion is created by quickly displaying related images. In a sequence of image frames in which an object appears in different positions, the object may appear to move. Although the motion of the object may appear to be continuous, each frame of the animation is a separate image that is displayed momentarily. Thus, the quality of each frame will affect the quality of the animation or illusion of motion. However, depending upon the rendering algorithm, representing motion may result in the creation of motion artifacts. The more noticeable effects include “crawling” and “popping” of pixels on a moving edge, for example, an edge of a moving object having a value that contrasts against a different value background.

For example, consider an object, of a first color and having a straight edge, that appears to be moving across a background of a second color. As the edge of the object moves across a pixel, there must be a determination as to when the color of the pixel changes from the color of the background to the color of the object. If a single sample point within the pixel is taken to determine its color, then, when the edge of the object passes this single, sampling location, the color of the pixel is changed. The location of a single sample point is typically the center of the pixel, and consequently, the value of the pixel is determined by the value calculated for the center of the pixel. As a result of a single sample point determination for the value of a pixel in a sampled image, the edge of an object may extend well into the region represented by the pixel, but the pixel may have the value of the background, because the edge has not reached the sampling point at the center of the pixel.

When multiple images, or frames, are displayed in sequence, to provide the illusion of objects in motion, pixels along the edge of an object may “pop” from one color or value to another. This effect can be distracting for a viewer. The relative motion of an object with respect to the orientation of the pixels of the image may be such that pixels along the edge of the object pop values in a manner and with a regularity that creates a visual effect of the edge of the object “crawling.”

There have been many different approaches to addressing the issue of aliasing. Aliasing includes such static edge-effects as “staircasing” and such motion artifacts as “pixel popping” and crawling. One such approach is to increase the resolution, or the number of pixels used to represent an image. The available resolution of computer graphics displays has increased dramatically, reducing, but not eliminating, aliasing. Similarly, printing devices have been increasing resolution, as well. However, there are practical limitations on the manufacturing of displays and other devices used for forming or recording an image. In addition, there are practical limitations with respect to the computation components which can be devoted to rendering an image. Processing more samples, at the centers of more pixels, takes longer, on a given device. Moreover, no matter how high a (finite) resolution is used to represent a graphics image, so long as the value of each pixel is only approximated from calculated values for discrete, sample points, the image is subject to some degree of aliasing, and a sequence of such images is subject to motion artifacts.

However, aliasing can be “anti-aliased” to some degree, by taking advantage of the number of values available for each pixel. More specifically, multi-sampling systems for anti-aliased rendering use sample values from multiple samples taken from a pixel region in determining the value of the respective pixel. When multi-sampling is applied to our example, above, as the edge of the object passes the first sample point encountered, the pixel is given a value that is a compromise between the value of the object and the disparate value of the background. Let's assume that the size, shape and motion of the object result in the object gradually and completely covering the pixel, one sampling point at a time. The value given to the pixel changes, each time the object covers another sample point of the pixel, until all of the sample points share the color of the object, at which time the pixel takes on the color of the object. The value of the pixel more accurately represents the proportion of the pixel occupied by the object at any moment, and over time.

The multiple samples for each pixel are typically arranged, within a region associated with the pixel, in an ordered pattern, such as in a rectangular grid, or in a pseudo-random fashion. We will refer to any arrangement of samples with respect to a pixel as a “sampling pattern”, or “sample pattern”. Regions associated with neighboring pixels may overlap. Pseudo-random multi-sampling per pixel generally requires a large number of samples per pixel, and considerable computation. Some anti-aliasing methods employ sampling patterns designed to simulate random sampling, and they, too, typically compute a large number of samples.

Although conventional multi-sample anti-aliasing methods generally can reduce motion artifacts and edge effects, aliasing remains. For example, a solid square, with edges parallel to the axes of the image, moving vertically, may create a popping effect by encountering multiple sample points within a pixel, simultaneously, if the sample points are arranged in a rectangular grid, within the pixel. Taking more samples per pixel may reduce the severity of motion artifacts, but processing overhead and economic considerations will place practical limits on the maximum number of samples that can be reasonably taken per pixel.

Therefore, there is a need for an alternative system and method for rendering an image, while reducing aliasing, such as motion artifacts and edge effects.

### SUMMARY OF THE INVENTION

The present invention relates to a method and system for performing multisample, anti-aliased rendering of images. The value of a pixel of an image is computed from one or more sample values, each computed at a respective sample point, position, or location, the sampling points, positions, or locations for a pixel being arranged in a sampling pattern. We will refer to “sampling point,” “sample point,” “sampling location,” “sample location,” “sampling position,” or “sample position” interchangeably. Different sampling patterns may apply to different pixels. An alternate sampling pattern may be applied to alternate pixels along lines parallel to a first axis and/or along lines parallel to a perpendicular second axis. A repeating sequence of sampling patterns may be applied to consecutive pixels along a row or column. Also, a sampling pattern may have four sample locations within the region of a pixel. The four samples are arranged within the pixel region such that were the pixel region divided into a four-by-four array of sub-regions, the four sample locations would be arranged within the pixel region in a manner such that no two samples are located in the same row, column, or diagonal of sub-regions. A sampling pattern may use only two or three of these four potential positions. A sampling pattern may be applied repeatedly to a pixel. Sample values taken for a pixel may be combined and cumulated with previously calculated and stored values. Within a frame the same sampling pattern and the same sampling locations may be used each time a pixel is sampled in order to avoid introducing artifacts. Sample values for a pixel are combined to calculate a value for the pixel.

### BRIEF DESCRIPTION OF THE DRAWINGS

FIG. 1 is a block diagram of a system in which embodiments of the present invention are implemented.

FIG. 2 is a block diagram of a graphics processing system in the system of FIG. 1.

FIG. 3 is a diagram of a multi-sample pattern according to an embodiment of the present invention.

FIG. 4 is a diagram of a multi-sample pattern according to another embodiment of the present invention.

FIGS. 5a and 5b are a diagram of a multi-sample pattern according to another embodiment of the present invention.

FIG. 6 is a diagram of a multi-sample pattern according to another embodiment of the present invention.

FIG. 7 is a diagram of a multi-sample pattern according to another embodiment of the present invention.

FIG. 8 is a diagram of a multi-sample pattern according to another embodiment of the present invention.

FIG. 9 is a diagram of a multi-sample pattern according to another embodiment of the present invention.

### DETAILED DESCRIPTION OF THE INVENTION

Embodiments of the present invention render anti-aliased images by reducing artifacts in both static images and also in motion pictures or animation. The systems and methods described herein perform anti-aliased rendering through a process of taking multiple samples, or “over-sampling,” for calculating values of pixels such as color or depth values in forming a resulting computer graphics image. Certain details are set forth below to provide a sufficient understanding of the invention. However, it will be clear to one skilled in the art that the invention may be practiced without these particular details. In other instances, well-known circuits, control signals, timing protocols, and software operations have not been shown in detail in order to avoid unnecessarily obscuring the invention.

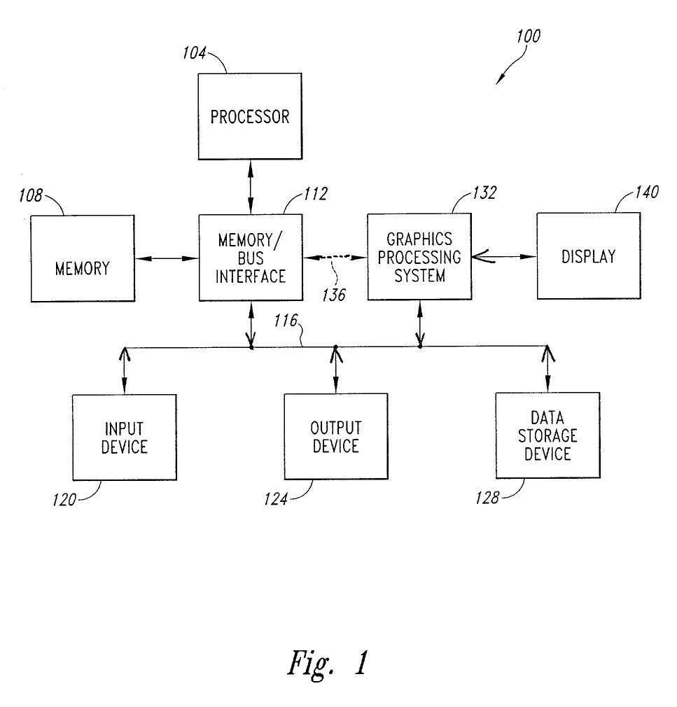

FIG. 1 illustrates a computer system 100 in which embodiments of the present invention are implemented. The computer system 100 includes a processor 104 coupled to a memory 108 through a memory/bus interface 112. The memory/bus interface 112 is coupled to an expansion bus 116, such as an industry standard architecture (ISA) bus or a peripheral component interconnect (PCI) bus. The computer system 100 also includes one or more input devices 120, such as a keypad or a mouse, coupled to the processor 104 through the expansion bus 116 and the memory/bus interface 112. The input devices 120 allow an operator or an electronic device to input data to the computer system 100. One or more output devices 124 are coupled to the processor 104 to receive output data generated by the processor 104. The output devices 124 are coupled to the processor 104 through the expansion bus 116 and memory/bus interface 112. Examples of output devices 124 include printers and a sound card driving audio speakers. One or more data storage devices 128 are coupled to the processor 104 through the memory/bus interface 112 and the expansion bus 116 to store data in, or retrieve data from, storage media (not shown). Examples of storage devices 128 and storage media include fixed disk drives, floppy disk drives, tape cassettes and compact-disc read-only memory drives.

The computer system 100 further includes a graphics processing system 132 coupled to the processor 104 through the expansion bus 1 16 and memory/bus interface 112. Optionally, the graphics processing system 132 may be coupled to the processor 104 and the memory 108 through other types of architectures. For example, the graphics processing system 132 may be coupled through the memory/bus interface 112 and a high speed bus 136, such as an accelerated graphics port (AGP), to provide the graphics processing system 132 with direct memory access (DMA) to the memory 108. That is, the high speed bus 136 and memory bus interface 112 allow the graphics processing system 132 to read and write memory 108 without the intervention of the processor 104. Thus, data may be transferred to, and from, the memory 108 at transfer rates much greater than over the expansion bus 116. A display 140 is coupled to the graphics processing system 132 to display graphics images. The display 140 may be any type of display, such as those commonly used for desktop computers, portable computers, and workstations, for example, a cathode ray tube (CRT), a field emission display (FED), a liquid crystal display (LCD), or the like.

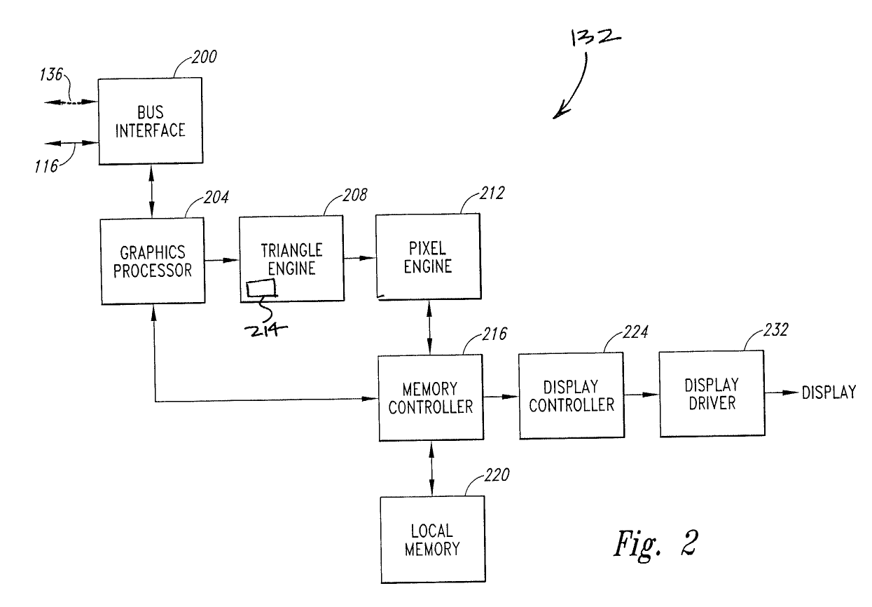

FIG. 2 illustrates circuitry included within the graphics processing system 132 for performing various graphics and video functions. As shown in FIG. 2, a bus interface 200 couples the graphics processing system 132 to the expansion bus 116 and optionally high-speed bus 136. In the case where the graphics processing system 132 is coupled to the processor 104 and the memory 108 through the high speed data bus 136 and the memory/bus interface 112, the bus interface 200 will include a DMA controller (not shown) to coordinate transfer of data to and from the host memory 108 and the processor 104. A graphics processor 204 is coupled to the bus interface 200 and is designed to perform various graphics and video processing functions, such as, but not limited to, generating vertex data and performing vertex transformations for polygon graphics primitives that are used to model 3D objects. The graphics processor 204 is coupled to a triangle engine 208 that includes circuitry for performing various graphics functions, such as clipping, attribute transformations, rendering of graphics primitives, and generating texture coordinates for a texture map. The triangle engine further includes anti-aliasing circuitry 214 according to embodiments of the present invention. As will be described in more detail below, embodiments of the anti-aliasing circuitry 214 over-sample within the pixels of the graphics image to reduce aliasing artifacts.

A pixel engine 212 is coupled to receive the graphics data generated by the triangle engine 208. The pixel engine 212 contains circuitry for performing various graphics functions, such as, but not limited to, texture application or mapping, bilinear filtering, fog, blending, and color space conversion. A memory controller 216 coupled to the pixel engine 212 and the graphics processor 204 handles memory requests to and from a local memory 220. The local memory 220 stores graphics data, such as pixel values. A display controller 224 is coupled to the memory controller 216 to receive processed values for pixels that are to be displayed. The output values from the display controller 224 are subsequently provided to a display driver 232 that includes circuitry to provide digital signals, or convert digital signals to analog signals, to drive the display 140 (FIG. 1). It will be appreciated that the circuitry included in the graphics processing system 132 to practice embodiments of the present invention may be of conventional designs well understood by those of ordinary skill in the art.

Although the anti-aliasing circuitry 214 is illustrated in FIG. 2 as being included within the triangle engine 208, it will be appreciated that the anti-aliasing circuitry 214 which may include various memory units, for example to store sampling patterns, may also be a circuit separate from the triangle engine 208, and/or included in one of the aforementioned circuit blocks of the graphics processing system 132, such as the pixel engine 212. Moreover, the anti-aliasing circuitry 214 may be spread between various circuit blocks of the graphics processing system 132. For example, steps of the anti-aliased rendering operation may be shared between the triangle engine 208 and the pixel engine 212. That is, when geometric primitives are rendered by the triangle engine 208, sample values are calculated for each sample point, typically of each pixel having a portion covered by the geometric primitive. Once the over-sampling is performed, the pixels may be further processed, for example, for depth, texture, and the like, and then the pixel engine 212 may perform the down-sampling or combining of the multiple sample values. Therefore, the particular location of the anti-aliasing circuitry 214 is a detail that may be modified without deviating from the subject matter of the invention, and should not be used in limiting the scope of the present invention. The description provided is sufficient to enable those of ordinary skill in the art to practice the invention, and consequently, in the interest of brevity, a more detailed description of the particular circuitry of the anti-aliasing circuitry 214 has been omitted from herein.

As previously mentioned briefly, the anti-aliasing circuitry 214 facilitates anti-aliasing by over-sampling for at least some pixels of a graphics image. The sample values for the multiple samples for a pixel are calculated for each triangle or other primitive covering, or partially covering, the pixel. The sample value for a given sample position within a given pixel may be stored and/or altered, for example by well-known z-buffer techniques, in accordance with the processing of other data, such as other primitives touching the same sample position in the same pixel. Later, the final sample values for a given pixel are then combined, in the pixel engine or texture engine (not shown) or blend unit (not shown), to determine a sample value for the pixel in the resulting image. Anti-aliased rendering by taking multiple samples is known in the art. However, as described in the Background of the Invention, conventional methods of anti-aliased rendering nevertheless still suffer, for example, from motion artifacts related to moving objects having edges aligned with the axes of the pixel coordinate system. Embodiments of the present invention use a more sophisticated over-sampling method than in conventional anti-aliasing rendering methods. Simply increasing the number of sampling points per pixel would suffer from the shortcomings previously described. Instead, the number and positions of samples taken for a pixel, according to each particular sampling pattern to be used, as well as the selection of the particular pattern of samples to be applied to a given pixel, are arranged to improve processing efficiency and/or perceived visual quality.

It will be appreciated that the sample values may represent values such as color values or grayscale values and/or depth values, etc., at a sample location. It will be further appreciated that the sample values for the samples may consist of several different components. For example, a sample value may represent not only a pixel color, as a combination of red, green, and blue color components, but also a depth value. Another example includes sample values representing pixel colors which are combinations of luma and chroma components. Consequently, because it is well understood in the art, although circuitry to perform graphics operation for each of the components is not expressly shown or described herein, embodiments of the present invention include circuitry, control signals, and the like necessary to perform operations on each component for multi-component sample values.

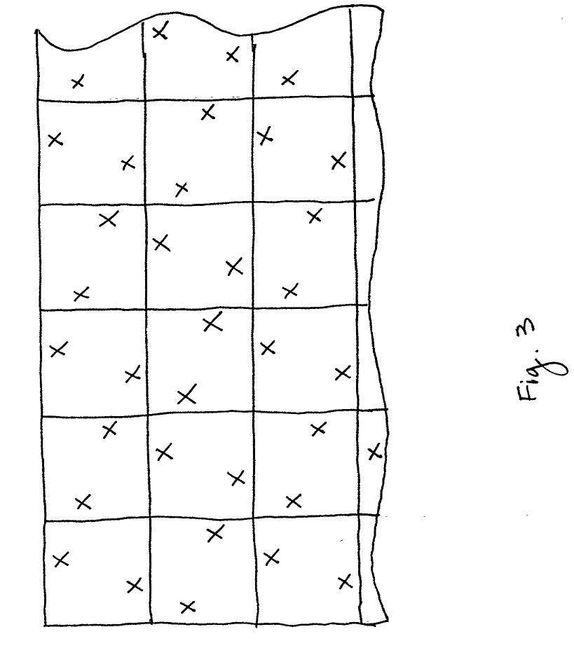

Illustrated in FIG. 3 is a sampling pattern according to an embodiment of the present invention that may be used by the anti-aliasing circuitry 214 (FIG. 2). The sampling pattern is referred to herein as the “alternating 2 Queens” pattern. The pixels shown in FIG. 3 are arranged in rows and columns, and define a pixel region from which samples are taken. The sampling pattern defines the sampling locations within a pixel region at which sample values are calculated. The sample locations are relative to a pixel. In the alternating 2 Queens sampling pattern, two samples are taken per pixel region, or per pixel. The two samples, from one pixel to the next, alternate between being arranged off-vertical and off-horizontal, such that every other pixel has the same arrangement of two sampling points. As with the conventional anti-aliasing methods, the resulting value for a pixel is derived from a contribution from each sample value. By over-sampling the pixels using the sample locations illustrated in FIG. 3, motion can appear smoother than when not using oversampling, yet only two samples are taken, per pixel. Pixel-popping is reduced, since a pixel can attain an intermediate value as the object engulfs one sample position at a time. When an object having an edge parallel to an axis of the pixel coordinate system is in motion across a display, two sample positions parallel to the moving edge would be all in, or all out, simultaneously. Thus, the pixel value would, at once, pop from background value to object value, with no intermediate value, such as would be attained when using the positions defined by the alternating 2 Queens pattern. Arguably, objects in motion and having edges in alignment with the samples within the pixels will still suffer from motion artifacts. However, vertical and horizontal edges are very common and numerous in scenes, and thus, more problematic, when they predominate. Thus, the alternating 2 Queens pattern reduces aliasing caused by the more numerous types of edges typically encountered. Also, with the alternating 2 Queens method, aliasing introduced by a line lying at the same angle as the samples in a given pixel will not tend to extend to the next pixel, as that pixel's samples lie at a different angle. Consequently, although the over-sampling pattern previously described does not eliminate motion artifacts completely, anti-aliasing methods using this sampling method can produce images having a more natural visual appearance.

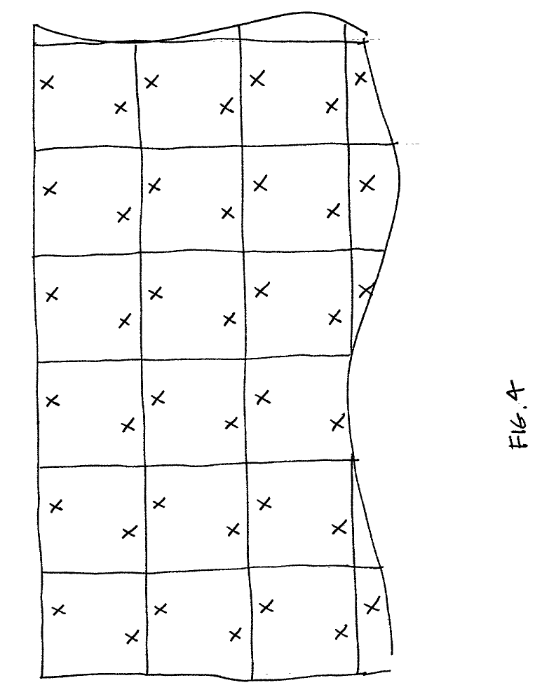

FIG. 4 illustrates a sampling pattern referred to as “2 Queens.” The sampling pattern is similar to the alternating 2 Queens pattern shown in FIG. 3, however, rather than alternating the sampling pattern every pixel, the sampling pattern remains the same for each of the pixels. As shown in FIG. 4, the two sample locations are arranged substantially along the vertical direction. However, it will be appreciated that the 2 Queens pattern of FIG. 4 can be itself modified by having the sample positions substantially arranged along a horizontal axis.

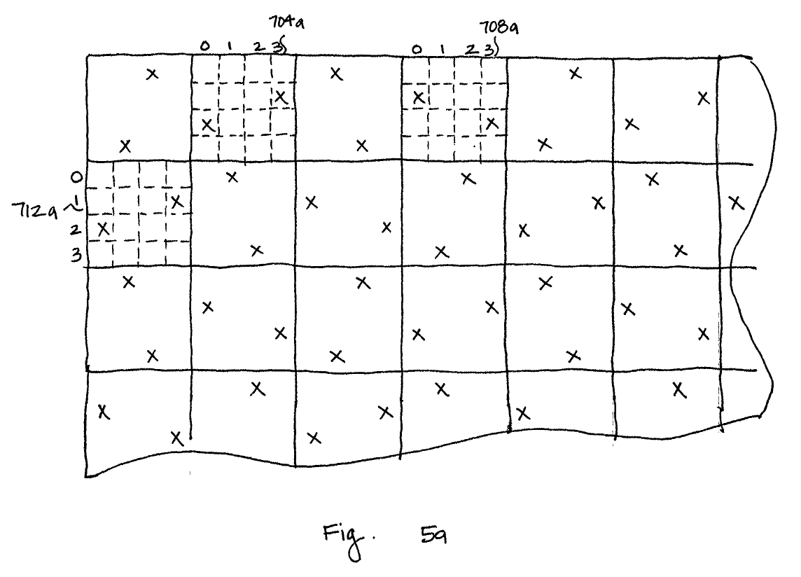

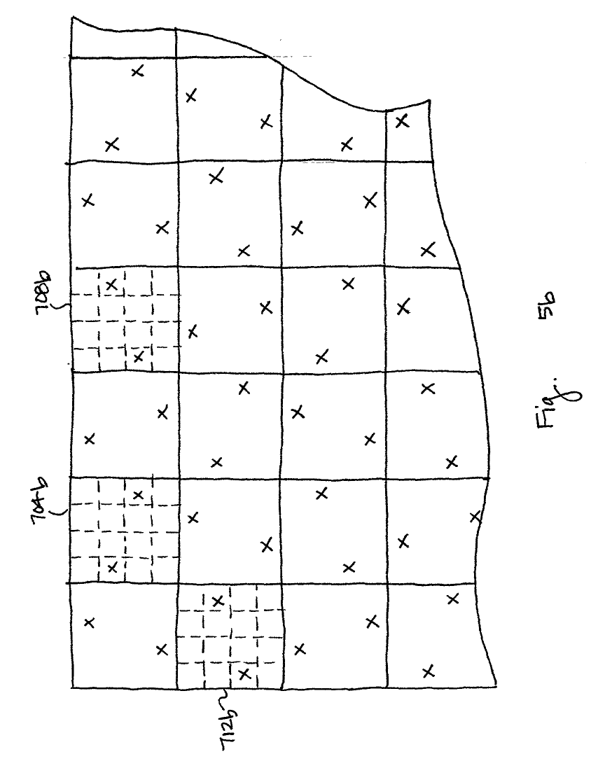

FIGS. 5a and 5b illustrate sampling patterns resulting from modifications of the alternating 2 Queens pattern shown in FIG. 3. As discussed with respect to FIG. 3, in the alternating 2 Queens pattern every second pixel has the same arrangement of two sampling points. In FIGS. 5a and 5b, this aspect of the alternating 2 Queens is modified such that the arrangements of the samples in every second pixel are mirror images. That is, the sampling patterns for every fourth pixel are the same. The resulting sampling pattern will be referred to herein as a “mirrored alternating 2 Queens” sampling pattern.

The sampling patterns illustrated in FIGS. 5a and 5b are only two of many different arrangements that may be made in accordance with the rules of the mirrored alternating 2 Queens sampling pattern. For example, as illustrated in FIG. 5a, if the region defined by a pixel is divided into a four-by-four array of sub-elements, the sampling positions of pixel 704a are located at (3, 1) and (0, 2), and the sampling positions of pixel 708a, (0, 1) and (3, 2). That is, pixel 708a has sampling positions that are arranged as the mirror image of pixel 704a. In comparison, in FIG. 5b, the sampling positions of pixel 704b are located at (0, 1) and (3, 2) and pixel 708b has sampling positions located at (0, 2) and (3, 1). Thus, although the sampling positions of 704 and 708 are mirror images of the other in both FIGS. 5a and 5b, according to the rule for the alternating 2 Queens pattern, the sampling patterns of the two figures are different. Similarly, another modification that can be made is the positional relationship of the two samples of pixel 712 and pixel 704. That is, in FIG. 5a, the two samples of pixel 712a are arranged in the same fashion as for pixel 704a, but in FIG. 5b, the samples of pixel 712b are a mirror image of 704b. Additionally, it will be appreciated that the rule of mirror image sampling for every other pixel can be applied not only for pixels along both axes of the image, as shown in FIGS. 5a and 5b, but may be applied either only along the rows, or only along the columns, of pixels of an image. Thus, modifications such as these may be made to change the overall sampling pattern but still fall within the scope of the present invention.

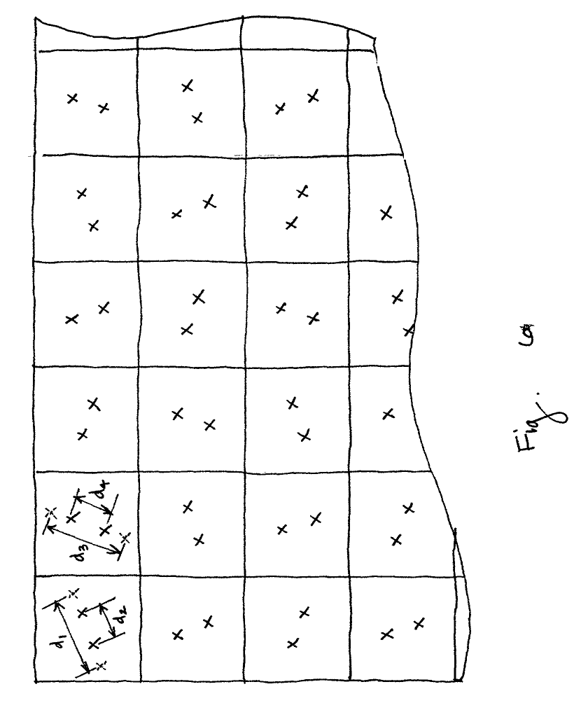

The sampling patterns illustrated in FIGS. 4 and 5 effectively reduce aliasing in graphics images; however, a side-effect of the anti-aliasing operation is the introduction of noise into the images. In the embodiment illustrated in FIG. 6, a mirrored alternating 2 Queens pattern is used for sampling. However, the distance between the two samples of a pixel have been reduced in comparison to the alternating 2 Queens patterns shown in FIGS. 4 and 5. Reducing the distance between the two samples of a pixel changes the balance between noise and anti-aliasing. That is, as the samples are located more toward the center of a pixel, the noise resulting from the anti-aliasing operation is reduced, but at the expense of also reducing the amount of anti-aliasing. Varying the distance of the sample locations within a pixel is a mechanism by which the relationship between the noise created by the anti-aliasing operation and the amount of anti-aliasing applied to an image can be adjusted. The angles used may vary, as well.

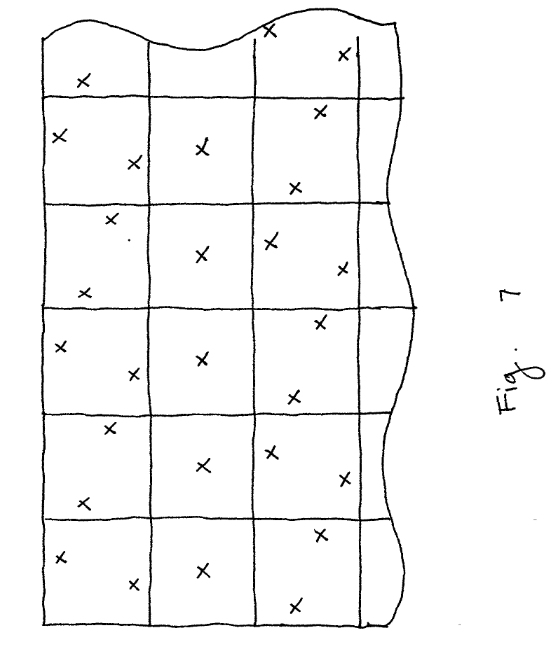

FIG. 7 illustrates another sampling pattern that may be used in performing an anti-aliasing operation in accordance with an embodiment of the present invention. Similar to the alternating 2 Queens patterns previously discussed, the “multi-rate” sampling pattern employs some aspects of the 2 Queens patterns, but alternates the number of samples per pixel in an ordered fashion. As shown in FIG. 7, the second row of pixels are sampled only once, in the center, while an alternating 2 Queens pattern is applied to every other row of pixels. As shown in FIG. 7, the effective sampling rate is approximately equal to the average of the two sampling patterns, that is, approximately equal to a 1.5× sampling rate. It will be appreciated, however, that the frequency at which the sampling pattern changes may be modified without deviating from the scope of the present invention. For example, the sampling pattern may change every three rows (instead of every two, as shown in FIG. 7). Alternatively, the multi-rate sampling pattern may change per pixel. The changes in sampling pattern may occur along either axis of the image.

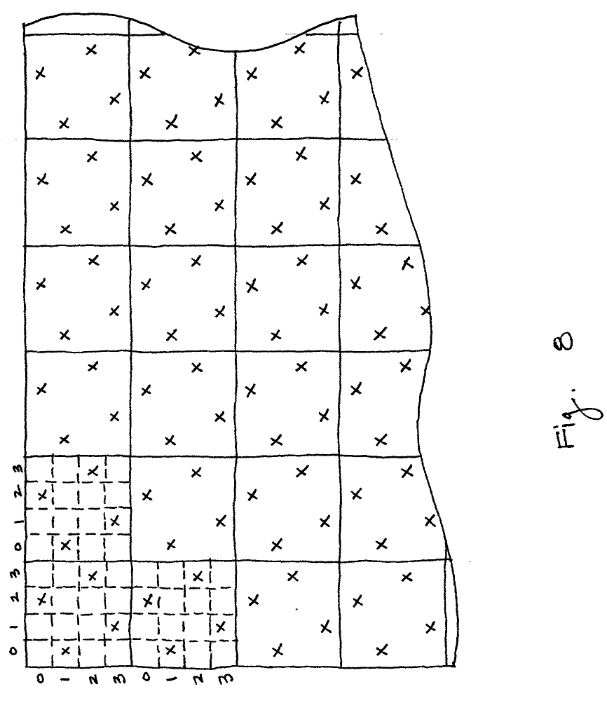

Illustrated in FIG. 8 is a sampling pattern according to another embodiment of the present invention that may also be used by the anti-aliasing circuitry 214 (FIG. 2). In contrast to the alternating 2 Queens patterns previously discussed, the anti-aliasing circuitry 214 uses four samples for each pixel. The locations of the four samples are described as follows. Each pixel region is conceptually divided into 16 sub-regions arranged in a four-by-four array of sub-regions as first illustrated in FIGS. 5a and 5b. The four sample points are arranged within the pixel region as shown in FIG. 8. Specifically, the samples are located at sub-element coordinates (2,0), (0, 1), (3, 2), and (1,3). The sample pattern illustrated in FIG. 8 is referred to as “4 Queens”, in reference to the game of chess. The pattern results from placing four queens at locations in the four-by-four matrix such that no queen is attacking another. That is, the region of a pixel is divided into a four-by-four array of sub-regions, and the four sample locations are arranged within the pixel region in a manner where no two samples are located along the same row, column, or diagonal of sub-regions.

The 4 Queens pattern is repeated for each pixel of the graphics image. Although the 4 Queens sampling pattern uses twice as many samples as the alternating 2 Queens sampling patterns previously discussed, and consequently, will require more processing, partial coverage of a pixel is more faithfully depicted, because the value computed for a pixel is based on the contribution of sample values from two additional samples. Thus, sub-pixel-stepped motion through a pixel, and/or objects half the width of a pixel, are more accurately portrayed.

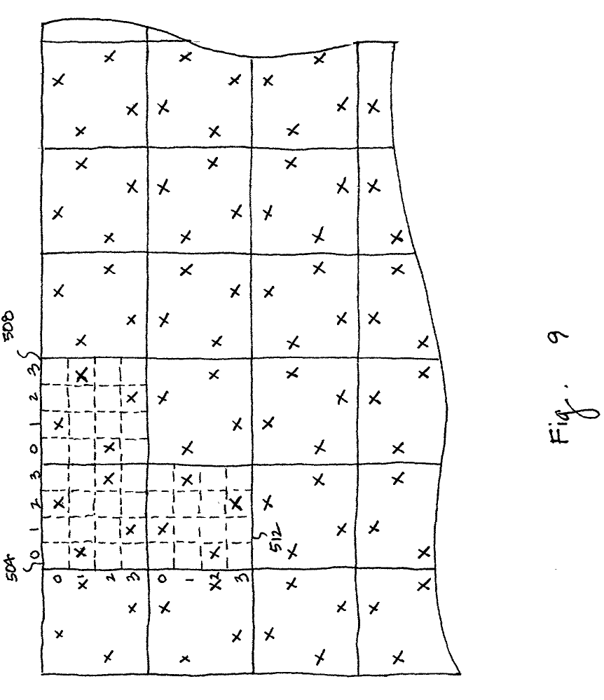

The sampling pattern described with respect to FIG. 8 can be modified in order to reduce the collinearity of samples along certain angles to the horizontal and vertical axes. FIG. 9 illustrates a possible modification. The 4 Queens sampling pattern of FIG. 8 is modified by using a second 4 Queens sampling pattern every other pixel. notice that the second sampling pattern also satisfies the 4 Queens criteria described with respect to FIG. 8.) This “alternating 4 Queens” rule is enforced along the rows and columns of the pixels such that the sampling patterns of row- and column-adjacent pixels are mirror images of one another. As a result, such adjacent pixels are sensitive to edges lying at different angles, and this addresses to some degree, artifact issues related to the 4 Queens sampling pattern of FIG. 8.

The 4 Queens and alternating 4 Queens sampling patterns illustrated in FIGS. 8 and 9, respectively, use four sample points per pixel. However, where processing capabilities of the anti-aliasing circuitry 214 or the graphics processing system 132 (FIG. 2) are limited, having four samples per pixel may reduce overall system performance. Thus, a compromise in image quality in return for using fewer samples per pixel, such as with the alternating 2 Queens patterns previously discussed with respect to FIGS. 4 and 5, may be an acceptable alternative. On the other hand, where greater processing capabilities are available, or where the number of samples taken for each pixel is inconsequential, alternative alternating sampling patterns can be implemented without deviating from the scope of the present invention. That is, although alternating sample patterns have been previously shown in and described with respect to the sampling patterns of FIGS. 3 and 9, other alternating sample patterns having any plurality of sample locations can also be used in embodiments of the present invention.

It will be appreciated that many of the previously described methods can be more generally described as using more than one sampling pattern to calculate values for pixels of an image. For example, the alternating 2 Queens and alternating 4 Queens methods both have at least two different sampling patterns that are used in calculating values for a pixel. It will be further appreciated that many other techniques using multiple sampling patterns can be developed as well. Additionally, it should be noted that to avoid a “boiling” effect, the same pattern is typically used in the same pixel position in successive frames. A “cut” to a different scene is a general exception to this rule of thumb. However, in most cases, the pattern applied should be the same for the same pixel, in subsequent frames, whatever the embodiment of the invention. It will be appreciated, however, that changing the sampling pattern for a pixel in successive frames nevertheless remains within the scope of the present invention. The following sampling patterns and sampling methods are provided by way of example, and are not intended to limit the scope of the present invention.

In one embodiment, the sampling patterns for a first group of pixels (e.g., pixels 1-4) may repeat, in the same order, for a second group of pixels (e.g., pixels 5-8). The patterns of the first and second groups of pixels are repeated in the same sequence along either or both axes. For example, pixels 9-12, pixels 13-16, and so on, have the same sequence of sampling patterns as pixels 1-4. Thus, rather than having two sampling patterns alternate from pixel to pixel, a group of sampling patterns will repeat periodically from one group of pixels to the next. Two alternating patterns comprise a periodically repeating group, namely a group of 2 patterns.

In an alternative embodiment, a set of sampling patterns can be defined for use, and, on a per-pixel basis, one of the sampling patterns can be selected for use when calculating a value for a pixel. The selection process may be predetermined, or, may actually occur as calculation of the sample values proceeds. The sampling patterns can have various numbers of samples and have several arrangements of sample locations. Moreover, the method by which a sampling pattern is selected for a pixel can be made by various techniques. For example, five different sampling patterns S₀-S₄ may be programmed into memory for the set of sampling patterns. The memory into which the sampling patterns are programmed is a conventional memory device such as a read-only memory (ROM), dynamic random access memory (DRAM), or a static random access memory (SRAM), or the like. Such a memory may be included in the local memory 220 (FIG. 2) or in one of the other functional blocks shown in FIG. 2, for example, the triangle engine 208, or in a separate unit (not shown). With a ROM, of course, the patterns may not be changed during operation.

When values for a pixel are to be calculated, a selection method is employed to determine which of the five sampling patterns will be used for the pixel. In one embodiment, the sampling patterns are selected in the same sequence as they are stored in memory. Each successive pixel, e.g., along a row, is sampled according the pattern stored in memory following the pattern applied to the predecessor pixel. In another embodiment, the selection of the sampling pattern is made by use of a pseudo-random technique where a selection algorithm attempts to simulate a random selection of the sampling pattern. In another embodiment, the selection of a sampling pattern from the set of five is made using a random selection. It will be appreciated that there are many well-known techniques for implementing the selection techniques described herein, and, although a more detailed description of the various techniques has not been provided, those of ordinary skill in the art have sufficient understanding to practice embodiments of the present invention.

In an alternative embodiment of the present invention, rather than having pre-defined sampling patterns from which one is selected when calculating sample values for a pixel, a deterministic technique is used to compute the sample locations from which values for a pixel are calculated. For example, a pixel region may be thought of as divided into sixteen different sub-regions arranged in a four-by-four array as previously mentioned. The center of each of the sub-regions represents a location at which a sample can be calculated. Determination of which of the sixteen potential locations will be sampled can be made using a deterministic selection technique. A simple example of such a selection technique is to increment through a four-bit value where each binary value represents a different sample location of the sixteen available. It will be appreciated that other deterministic selection techniques can be developed by those of ordinary skill in the art. It will be further appreciated that although the selection of a sample location within a pixel has been described with respect to a single sample location, a plurality of samples may be calculated for a pixel as well, each of the sample locations determined in accordance with a deterministic selection technique. It will be appreciated that the embodiments previously described may be implemented either by the deterministic scheme of this paragraph, or by the “patterns-in-memory” regime of the previous paragraph, or by some combination of both, or by other means.

In another embodiment of the present invention, the various sampling patterns described herein may be used in a sampling method where the sampling positions of a sampling pattern are “jittered” when calculating the sample values for a pixel in the image. That is, a sampling pattern is defined, and, prior to calculating sampling values, its sampling positions are altered at the sub-pixel level. In effect, when a pattern is applied to a pixel, different pseudo-random or random offsets, varying independently in x and y, are added to the coordinates of each sample position, before the samples are calculated. Conventional methods do such jittering for patterns comprising regular grids of samples. (Different offsets may be used for the same pixel, from frame to frame, although generally, the same pattern should be used before the offsets are applied.) In this manner, correlation of sample locations is diminished, and consequently, the occurrence of artifacts such as staircasing, pixel popping, and pixel crawling, will be reduced. Typically, the same offsets would be used for a given pixel for all sampling within a frame, as above.

In another embodiment, a linear transformation including a rotation of the sampling pattern may also be used for shifting, on a per pixel basis, the sampling locations of a sampling pattern.

As previously discussed, a value for a pixel is calculated from the respective sample values. Many well known calculation techniques for calculating values for pixels from the respective sample values may be used in embodiments of the present invention. For example, combinations of sample values can be cumulated from and to stored sample values for finally calculating a value for a pixel from respective stored cumulated sample values. For example, this is done in z-buffer methods, where z is depth.

Selection of which sampling patterns or combinations or sequences of patterns to employ may be based on the type of image being represented by the pixel information. For example, one sampling pattern may be better suited for a particular game with animation, whereas another sampling pattern may be better suited for some particular still images. One game may include sequences optimized by different patterns, and embodiments of the present invention permit re-programming. Patterns may be used in various combinations and sequences, even within a frame or single image, as warranted by the image content. Thus, a system or method may use more than one sampling pattern to optimize image quality.

It will be appreciated that embodiments of the present invention may be practiced using conventional software language and conventional hardware circuitry well understood by those of ordinary skill in the art. In either case, the description provided herein is sufficient to allow those of ordinary skill in the art to practice the present invention without the need for undue experimentation. Moreover, as previously mentioned, certain details have been set forth above to provide a sufficient understanding of the invention. However, it will be clear to one skilled in the art that the invention may be practiced without these particular details. In other instances, well-known circuits, control signals, timing protocols, and software operations have not been shown in detail in order to avoid unnecessarily obscuring the invention.

Thus, from the foregoing it will be appreciated that, although specific embodiments of the invention have been described herein for purposes of illustration, various modifications may be made without deviating from the spirit and scope of the invention. For example, embodiments of the present invention have been described as being implemented in a computer system, and more specifically, a graphics processing system included in the computer system. However, embodiments of the present invention may be implemented in other systems where graphics processing is desirable, such as gaming systems, set-top boxes for cable television, printing devices, and the like. More generally, embodiments of the present invention may be implemented in general processing environments, where the sampling techniques described herein are carried out by a general purpose computer. Additionally, although embodiments of the present invention have been described herein for application with 3D computer graphics, it will be appreciated that the present invention is also applicable to 2D graphics, where the sample values are calculated from scenes or other two-dimensional (2D) representations, and to the visualization of higher dimensional mathematics, image processing and so forth. Accordingly, the invention is not limited except as by the appended claims.

1. A method for calculating values for pixels of an image, comprising:
calculating sample values for pixels of an image in accordance with a sampling pattern for each pixel, the sampling pattern for consecutive pixels alternating between a first and a second sampling pattern, each sampling pattern defining one or more sampling locations at which sample values are calculated, the sampling locations being relative to a pixel; and
determining a value for at least one pixel by combining sample values calculated for the sampling locations for the pixel.

2. The method of claim 1 wherein each sampling pattern defines two sample locations and calculating sample values comprises calculating a pair of sample values whenever sample values for a pixel are calculated in accordance with the first or second sampling pattern, the sampling patterns alternating from one pixel to the next.

3. The method of claim 2 wherein the pixels of the image are arranged along rows and columns parallel to first and second perpendicular axes, respectively, and the pair of sample locations per sampling pattern for at least two pixels are arranged along a line parallel to neither axis.

4. The method of claim 2 wherein calculating a pair of sample values comprises calculating sample values at sample positions arranged according to either a first or second sampling pattern, the first sampling pattern having sample positions on opposite sides of a line parallel to a first axis and dividing a respective pixel region in two, and the second sampling pattern having sample positions on opposite sides of a line parallel to a second axis and dividing a respective pixel region in two, the second axis perpendicular to the first axis.

5. The method of claim 4 wherein the two lines parallel to the respective axes pass through the centers of respective pixels.

6. The method of claim 5 wherein each sampling pattern has a sample position on each side of both of two lines parallel to respective axes and passing through the center of respective pixels.

7. The method of claim 1 wherein calculating sample values comprises calculating four sample values at four respective sample locations within a respective pixel region whenever a sampling pattern is applied to a pixel, each pixel region considered as divided evenly into a four-by-four array of sub-regions and the four sample locations defined for a pixel by any given sampling pattern arranged within the pixel region in a manner whereby no two sample points defined by the same sampling pattern are located in the same row or column of sub-regions.

8. The method of claim 7 wherein no two sampling locations of the four defined by a given sampling pattern are located in the same row or column or diagonal of sub-regions.

9. The method of claim 8 wherein each sampling location lies substantially at the center of a sub-region.

10. The method of claim 8 wherein no two different sampling patterns applied to two different pixels define any two sampling locations which lie in corresponding sub-regions of their respective pixels.

11. The method of claim 10 wherein the sampling patterns alternate per pixel for vertically-consecutive pixels.

12. The method of claim 10 wherein the sampling patterns alternate per pixel for horizontally-consecutive pixels.

13. The method of claim 10 wherein the sampling patterns alternate per pixel both for horizontally-consecutive pixels and also for vertically-consecutive pixels.

14. A method for generating an image having pixels arranged in rows and columns parallel to first and second perpendicular axes, respectively, the method comprising:
calculating pairs of sample values for pixels of the image in accordance with a plurality of sampling patterns, one sampling pattern per pixel, one pair of sampling points per sampling pattern; and
calculating a value for at least one pixel of the image from a respective pair or pairs of calculated sample values.

15. The method of claim 14 wherein a first sampling pattern defines sample positions relative to a given pixel on opposite sides of a line parallel to a first axis of the image and dividing the respective pixel in two, and a second sampling pattern defines sample positions relative to a given pixel on opposite sides of a line parallel to a second axis of the image and dividing the respective pixel in two.

16. The method of claim 15 wherein the second sampling pattern comprises a sampling pattern substantially corresponding to the first sampling pattern rotated 90°.

17. The method of claim 15 wherein the sampling patterns alternate per pixel along at least one row or column of pixels.

18. The method of claim 15 wherein each of the two sampling patterns is applied to every other pixel along at least one row or column of pixels, the second sampling pattern substantially corresponding to the first sampling pattern rotated 90 degrees.

19. The method of claim 15 wherein the sampling pattern for each consecutive pixel alternates along a row or column of pixels between a given sampling pattern and its 90 degrees-rotated counterpart.

20. The method of claim 14 wherein all sampling patterns are considered as dividing the regions of respective pixels into the same four-by-four array of sub-regions and four potential sample positions are arranged within the array in a manner whereby no two potential sample positions are located in the same row, column, or diagonal of sub-regions, the plurality of sampling patterns comprising first and second sampling patterns, each defining two sampling positions from the four potential sampling positions, the first sampling pattern having sample locations in the first and fourth rows of the array and the second sampling pattern having sample locations in the second and third rows of the array.

21. The method of claim 14 wherein the sampling patterns alternate per pixel along at least one row or column of pixels.

22. The method of claim 14 wherein each of the two sampling patterns is applied to every other pixel along at least one row or column of pixels, the second sampling pattern substantially corresponding to the first sampling pattern rotated 90 degrees.

23. A method for calculating values for pixels of an image having the pixels arranged in rows and columns parallel to first and second perpendicular axes, respectively, the method comprising:
calculating sample values for pixels of the image in accordance with a plurality of sampling rates, the sampling rate differing for at least two pixels of the image; and
calculating values for pixels of the image from respective calculated sample values.

24. The method of claim 23 wherein the sampling rate alternates per pixel for consecutive pixels along lines parallel to one or the other axes of the image for at least some of the horizontal or vertical lines of pixels of the image.

25. The method of claim 23 wherein the sampling rate is constant for the pixels arranged along any given line parallel to the first axis and varies among the plurality of sampling rates for the pixels arranged along any given line parallel to the second axis.

26. The method of claim 25 wherein first and second sampling rates alternate per pixel for consecutive pixels in any line parallel to the second axis.

27. A method for calculating values for pixels of an image having the pixels arranged in rows and columns parallel to first and second perpendicular axes, respectively, the method comprising:
calculating sample values for pixels of the image in accordance with first and second sampling rates, the sampling rate remaining constant for consecutive pixels arranged along any one given line parallel to the first axis and varying between the first and second sampling rates for consecutive pixels arranged along any one given line parallel to the second axis; and
calculating values for pixels of the image from respective calculated sample values.

28. The method of claim 27 wherein the pixels of the image are arranged in rows parallel to the first axis and columns parallel to the second axis, and the first and second sampling rates alternate every row of pixels.

29. The method of claim 27 wherein the first sampling rate is two samples per pixel and the second sampling rate is one sample per pixel.

30. The method of claim 27 wherein the first sampling rate is two samples per pixel and the second sampling rate is one sample per pixel, the two sample locations per pixel for the first sampling rate arranged within a pixel along a line forming an acute angle with respect to either the first or second axes.

31. The method of claim 27 wherein the first sampling rate is two samples per pixel and the second sampling rate is one sample per pixel, the two samples per pixel for the first sampling rate arranged within a pixel substantially along and on opposite sides of a line parallel to either the first or second axes that divides the pixel in two, the axis to which the line is parallel alternating per consecutive pixel arranged along a line parallel to the first axis.

32. The method of claim 31 wherein the two samples per pixel of the first sampling rate vary for every other consecutive pixel lying along a line parallel to the first axis between a given sampling pattern and another sampling pattern which is substantially the same pattern rotated 90 degrees.

33. A method for calculating values for pixels of an image having its pixels arranged in rows and columns parallel to first and second perpendicular axes, respectively, the method comprising:
calculating sample values for pixels of the image in accordance with a sampling pattern having four sample locations relative to a pixel, the region of potential sampling locations considered as divided evenly into a four-by-four array of sub-regions and the four sample locations arranged in a manner whereby no two of the four sample locations are located in the same row or column of sub-regions; and
calculating values for pixels of the image from sample values calculated for respective pixels.

34. The method of claim 33 wherein no two of the four sample locations are located in the same row, column, or diagonal of sub-regions.

35. The method of claim 34 wherein the four sample locations are located substantially at the center of respective sub-regions.

36. The method of claim 34 wherein the four sample locations are located at the center of respective sub-regions.

37. A method for calculating values for pixels of an image, comprising:
calculating sample values for pixels of an image in accordance with a sampling pattern for each pixel, the sampling pattern varying per pixel between a first and a second sampling pattern, each pattern having four sample locations relative to a pixel, the region of potential sampling locations considered as evenly divided into a four-by-four array of sub-regions and the four sample locations arranged in a manner whereby no two of the four sample locations from a given sampling pattern are located along the same row, column, or diagonal of sub-regions; and
determining a value for at least two pixels by combining sample values calculated for the sampling locations for the pixel.

38. The method of claim 37 wherein the first and second sampling patterns alternate per consecutive pixel along at least part of at least one line parallel to a first axis of the image.

39. The method of claim 38 wherein the first and second sampling patterns alternate per consecutive pixel along at least part of at least one line parallel to a second axis of the image, perpendicular to the first axis.

40. A method for calculating values for pixels of an image having its pixels arranged in rows and columns parallel to first and second perpendicular axes, respectively, the method comprising:
calculating sample values for pixels of the image in accordance with one or more sampling patterns, the region of potential sampling locations relative to a pixel considered as divided evenly into a four-by-four array of sub-regions each sampling pattern having at least two sample locations relative to a pixel, each sample location located at one of four candidate sampling locations, and the candidate sampling locations arranged in a manner whereby no two of the four candidate sample locations for a given sampling pattern are located along the same row, column, or diagonal of sub-regions; and
calculating values for pixels of the image from sample values calculated for respective pixels.

41. The method of claim 40 wherein at least one sampling pattern includes at least one other sampling location not located in one of the candidate sampling locations, no more than seven sub-regions containing any sampling location.

42. A method for calculating values for pixels of an image having its pixels arranged in rows and columns parallel to first and second perpendicular axes, respectively, the method comprising:
calculating sample values for pixels of the image in accordance with a sampling pattern, the region of potential sampling locations relative to a pixel considered as divided evenly into a four-by-four array of sub-regions, the sampling pattern having two sample locations relative to a pixel, each sample location located at one of four candidate sampling locations, and the candidate sampling locations arranged in a manner whereby no two of the four candidate sample locations for a given sampling pattern are located along the same row, column, or diagonal of sub-regions; and
calculating values for pixels of the image from sample values calculated for respective pixels.

43. The method of claim 42 wherein the two sample locations are located in the first and fourth rows of the array of sub-regions.

44. The method of claim 43 wherein the two sample locations are located substantially at the center of respective sub-regions.

45. The method of claim 43 wherein the two sample locations are located at the center of respective sub-regions.

46. The method of claim 42 wherein the two sample locations are located in the second and third rows of the array of sub-regions.

47. The method of claim 46 wherein the two sample locations are located substantially at the center of respective sub-regions.

48. The method of claim 46 wherein the two sample locations are located at the center of respective sub-regions.

49. A method for calculating values for pixels of an image having pixels arranged in rows and columns parallel to first and second perpendicular axes, respectively, the method comprising:
calculating sample values for pixels of the image in accordance with a plurality of sampling patterns, each pixel in the image having an associated sampling pattern, the sampling patterns associated with the pixels of a first group of horizontally or vertically consecutive pixels being repeated for at least one following group of the same number of pixels, the same sequence of patterns appearing within at least one following group; and
calculating a final value for a pixel of the image from respective calculated sample values.

50. The method of claim 49 wherein the pixels of the first group are arranged substantially along a line parallel to the first axis and the sampling patterns of the group repeat periodically for subsequent pixels along the same line.

51. The method of claim 50 wherein the pixels of a second group are arranged substantially along a line parallel to the second axis and the sampling patterns of the second group repeat periodically for subsequent pixels along the same line.

52. A method for calculating values for pixels of an image having pixels arranged in rows and columns parallel to first and second perpendicular axes, respectively, the method comprising:
calculating sample values for pixels of the image in accordance with a plurality of sampling patterns; and
calculating values for pixels of the image from respective calculated sample values.

53. The method of claim 52 wherein the plurality of sampling patterns comprises a set of addressable sampling patterns stored in a writable memory.

54. The method of claim 52 wherein the sampling pattern for a given pixel is determined by a calculation based upon the row and/or column containing the pixel.

55. The method of claim 52 wherein determination of the sample locations comprising each sampling pattern is based on a deterministic calculation.

56. The method of claim 53, further comprising selecting one sampling pattern from the plurality of sampling patterns to be applied when calculating sample values for a given pixel.

57. The method of claim 56 wherein selecting the one sampling pattern comprises randomly selecting one sampling pattern from the plurality.

58. The method of claim 56 wherein selection of the one sampling pattern is made in accordance with a pseudo-random selection method.

59. The method of claim 56 wherein selection of the one sampling pattern is made based on the sampling patterns selected for calculating sample values for pixels in the same row or column as the given pixel.

60. The method of claim 56 wherein selection of the one sampling pattern is made based on the row and/or column in which the given pixel lies.

61. The method of claim 60 wherein the sampling patterns define sampling locations substantially at the center of one or more of sixteen different regions, the sixteen regions evenly arranged in a four-by-four array of regions, each of the regions having the same shape and size.

62. A method for calculating values for pixels of an image having pixels arranged in rows and columns parallel to first and second perpendicular axes, respectively, the method comprising:
calculating sample values for pixels of the image in accordance with a fixed set of sampling patterns stored in a read-only memory; and
calculating values for pixels of the image from respective calculated sample values.

63. The method of claim 62 wherein the sampling pattern for a given pixel is determined by a calculation based upon the row and/or column containing the pixel.

64. The method of claim 62, further comprising selecting one sampling pattern from the set of sampling patterns to be applied when calculating sample values for a given pixel.

65. The method of claim 64 wherein selecting one sampling pattern comprises randomly selecting one sampling pattern from the set.

66. The method of claim 64 wherein selection of the one sampling pattern is made in accordance with a pseudo-random selection method.

67. The method of claim 64 wherein selection of the one sampling pattern is made based on the sampling patterns selected for calculating sample values for pixels in the same row or column as the given pixel.

68. The method of claim 64 wherein selection of the one sampling pattern is made based on the row and/or column in which the given pixel lies.

69. The method of claim 68 wherein the sampling patterns define sampling locations substantially at the center of one or more of sixteen different regions, the sixteen regions evenly arranged in a four-by-four array of regions, each region having the same shape and size.

70. A method for calculating values for pixels of an image having the pixels arranged in rows and columns parallel to first and second perpendicular axes, respectively, the method comprising:
shifting the sampling locations defined by one or more sampling patterns relative to a pixel; and
calculating sample values for at least one pixel in accordance with shifted sampling locations of a respective sampling pattern; and
calculating values for pixels from respective calculated sample values.

71. The method of claim 70 wherein the one or more sampling patterns are stored into a writable memory, the sampling pattern applied depending upon those stored in the memory.

72. The method of claim 71 wherein shifting sampling locations for a sampling pattern comprises adding an independently random or pseudorandom offset to each coordinate of each respective sampling location for each pixel.

73. The method of claim 70 wherein shifting the sampling locations of a sampling pattern comprises applying a linear transformation to the coordinates of the sampling locations of the sampling pattern.

74. The method of claim 70 wherein shifting sampling locations for a sampling pattern comprises adding an independently random or pseudorandom offset to each coordinate of each respective sampling location for each pixel.

75. The method of claim 70 wherein shifting the sampling pattern comprises shifting the sampling pattern parallel to either the first or second axis.

76. The method of claim 70 wherein at least one of the sampling patterns comprises a sampling pattern having four sample locations, the four sample locations arranged relative to a pixel within a region evenly divided into an array of 16 sub-regions in a manner whereby no two sample locations are located in the same row, column, or diagonal of sub-regions where the sub-regions are considered as arranged into a four-by-four array of sub-regions.

77. The method of claim 76 wherein shifting sampling locations for the sampling pattern comprises adding an independently random or pseudorandom offset to each coordinate of each of the four sample locations for each pixel.

78. The method of claim 70 wherein at least two of the sampling patterns is considered as dividing a given pixel into a four-by-four array of sub-pixels and four potential sample positions are arranged within the array in a manner where no two potential samples positions are located in the same row, column, or diagonal of sub-pixels, each of the two sampling patterns having two sampling positions from the four potential sampling positions, a first sampling pattern having sample locations in the first and fourth rows of the array and a second sampling pattern having sample locations in the second and third rows of the array.

79. The method of claim 78 wherein shifting sampling locations for the two sampling patterns comprises adding an independently random or pseudorandom offset to each coordinate of each of the two respective sample locations for each pixel.

80. The method of claim 70 wherein one sampling pattern is considered as dividing a given pixel into a four-by-four array of sub-pixels and four potential sample positions are arranged within the array in a manner where no two potential samples positions are located in the same row, column, or diagonal of sub-pixels, the sampling pattern having two sampling positions from the four potential sampling positions, the sampling pattern having sample locations in the first and fourth rows of the array.

81. The method of claim 80 wherein shifting sampling locations for the sampling pattern comprises adding an independently random or pseudorandom offset to each coordinate of each of the two respective sample locations for each pixel.

82. The method of claim 70 wherein one sampling pattern is considered as dividing a given pixel into a four-by-four array of sub-pixels and four potential sample positions are arranged within the array in a manner where no two potential samples positions are located in the same row, column, or diagonal of sub-pixels, the sampling pattern having two sampling positions from the four potential sampling positions, the sampling pattern having sample locations in the second and third rows of the array.

83. The method of claim 82 wherein shifting sampling locations for the two sampling patterns comprises adding an independently random or pseudorandom offset to each coordinate of each of the two respective sample locations for each pixel.

84. The method of claim 70 wherein at least one of the sampling patterns is considered as dividing a given pixel into a four-by-four array of sub-pixels and four potential sample positions are considered to be arranged within the array in a manner whereby no two potential sample positions are located in the same row, column, or diagonal of sub-pixels, the sampling pattern having two sampling positions from the four potential sampling positions.

85. The method of claim 84 wherein shifting sampling locations for the two sampling patterns comprises adding an independently random or pseudorandom offset to each coordinate of each of the two respective sample locations for each pixel.

86. An apparatus for rendering of an image having pixels arranged in rows and columns parallel to first and second perpendicular axes, respectively, the apparatus sampling at a plurality of sample locations relative to a pixel in accordance with a sampling pattern, the sampling pattern for a pixel alternating per pixel between first and second sampling patterns for consecutive pixels arranged along any given line parallel to the first axis and/or for consecutive pixels arranged along any given line parallel to the second axis, the apparatus further calculating values for pixels of the image from respective sample values.

87. An apparatus for rendering of an image having pixels arranged in rows and columns parallel to first and second perpendicular axes, respectively, the apparatus sampling pixels in accordance with at least one sampling pattern having two sample locations, the apparatus further cumulating sample values from and to stored sample values corresponding to the same sampling locations for finally calculating a value for a pixel from a respective pair of stored cumulated sample values.

88. The apparatus of claim 87 wherein a sampling pattern is considered as dividing a given pixel into a four-by-four array of sub-pixels and four potential sample positions are considered to be arranged within the array in a manner whereby no two potential sample positions are located in the same row, column, or diagonal of sub-pixels, at least one sampling pattern having two sampling positions from the four potential sampling positions.

89. An apparatus for rendering of an image having pixels arranged in rows and columns parallel to first and second perpendicular axes, respectively, the apparatus sampling a pixel in accordance with a sampling pattern having four sample locations, the apparatus further cumulating sample values from and to stored sample values corresponding to the same sampling locations for finally calculating a value for a pixel from respective stored cumulated sample values.

90. The apparatus of claim 89 wherein at least one sampling pattern has its four sample locations arranged relative to a pixel within a region considered as evenly divided into a four-by-four array of sub-regions in a manner whereby no two sample locations are located in the same row, column, or diagonal of sub-regions.

91. An apparatus for rendering of an image having pixels arranged in rows and columns parallel to first and second perpendicular axes, respectively, the apparatus calculating sample values for pixels in accordance with first and second sampling rates, the sampling rate remaining constant for consecutive pixels arranged along any given line parallel to the first axis and the sampling rate varying between the first and second sampling rates for consecutive pixels arranged along any given line parallel to the second axis, the apparatus further calculating values for the pixels of the image from the respective sample values.

92. An apparatus for rendering of an image having pixels arranged in rows and columns parallel to first and second perpendicular axes, respectively, the apparatus sampling pixels in accordance with a sampling pattern having four sample locations, the four sample locations arranged relative to a pixel within a region of potential sampling locations in a manner where no two sample locations are located in the same row, column, or diagonal of sub-regions where the region of potential sampling locations is considered as evenly divided into a four-by-four array of sub-regions, the apparatus further cumulating sample values from and to stored sample values corresponding to the same sampling locations for calculating a value for a pixel from respective sample values.

93. An apparatus for calculating values for pixels of an image, the apparatus comprising:
a first calculating means for calculating sample values at a plurality of sample locations relative to a pixel in accordance with a sampling pattern per pixel, the sampling pattern for a pixel alternating per pixel between a first and second sampling pattern for consecutive pixels arranged along any given line parallel to a first axis of the image and/or for consecutive pixels arranged along any given line parallel to a perpendicular second axis;
a second calculating means for calculating values for pixels by combining respective sample values;
a third calculating means for cumulating sample values; and
a memory means coupled to the first, second, and third calculating means for storing and retrieving cumulated sample values for respective pixels.

94. The apparatus of claim 93 wherein the first calculating means samples two sample locations per pixel in accordance with one per pixel of a plurality of sampling patterns.

95. The apparatus of claim 94 wherein the two sample locations are arranged relative to a pixel substantially along a line forming an acute angle with respect to either first or second axes.

96. The apparatus of claim 94 wherein the two sample locations are arranged according to either a first or second sampling pattern, the first sampling pattern having sample positions on opposite sides of a line parallel to the first axis of the image and dividing a respective pixel region in two, and the second sampling pattern having sample positions on opposite sides of a line parallel to the second axis of the image and dividing the respective pixel region in two.

97. The apparatus of claim 93 wherein each sampling pattern determines four sample locations relative to a pixel, the four sample locations arranged relative to a pixel within a region of potential sample locations, the region considered as evenly divided into a four-by-four array of sub-regions, the sample locations further arranged in a manner whereby no two sample locations in a given sampling pattern are located in the same row, column, or diagonal of subregions.
